(19) United States
(12) Patent Application Publication
(10) Pub. No.: US 2004/0051081 A1
(43) Pub. Date: Mar. 18, 2004

(54) Silica-based indicating desiccants

(76) Inventor: Stephen Moreton, Warrington (GB)

Correspondence Address: PILLSBURY WINTHROP, LLP, P.O. BOX 10500, MCLEAN, VA, 22102, US

(21) Appl. No.: 10/466,538

(22) PCT Filed: Jan. 4, 2002
(86) PCT No.: PCT/GB02/00032

(30) Foreign Application Priority Data
Jan. 19, 2001 (GB) 0101381.2

(51) Int. Cl. G01N 31/22

(52) U.S. Cl. 252/408.1; 504/164; 252/380; 252/963

(57) ABSTRACT

An indicating desiccant comprises a silica-based material having impregnated thereon a source of copper and a source of bromide, the source of copper being present in an amount up to 0.5 per cent by weight, calculated as Cu with respect to weight of the silica-based material, and the source of bromide being present in an amount such that the weight ration of Br to Cu is at least 5:1. Optionally, the indicating desiccant also comprises a dye or other coloured material.

This invention relates to silica-based indicating desiccants.

Cobalt chloride indicator silica gels are used in a range of applications, e.g. to indicate moisture uptake in gas drying columns. Other drying applications include their use in transformer breathers, tank breathers, in the protection of electronics and telecommunication systems and in laboratory desiccators. It is estimated that approximately 4000 tonnes of cobalt chloride indicator gel are used annually on a global basis.

Cobalt-containing gels for use as humidity indicators have been disclosed in U.S. Pat. No. 2,460,071 (disclosing cobalt chloride), U.S. Pat. No. 2,460,069 (disclosing cobalt bromide), U.S. Pat. No. 2,460,073 (disclosing cobalt iodide), U.S. Pat. No. 2,460,074 (disclosing cobalt thiocyanate), U.S. Pat. No. 2,460,065 (disclosing cobalt sulphate) and U.S. Pat. No. 2,460,070 (disclosing cobalt phosphate).

Indicator silica gel is currently produced by impregnating humidified silica gel or a silica hydrogel with a cobalt chloride solution to produce a dry, granular end-product which contains a minimum of 0.5% cobalt chloride and which is blue in colour, changing to pink when water has been adsorbed. Humidified gel is silica gel that has been saturated with water from the vapour phase in order to avoid decrepitation or disintegration upon impregnation. If the cobalt chloride solution is added directly to the dried gel, the grain size is reduced.

The hazard classification of cobalt chloride according to European legislation was recently amended (notification from the EEC, 15/12/98) with the consequence that the use of cobalt chloride indicator gel in industrial applications now requires much tighter control to ensure exposure limits are strictly controlled. If acceptable alternatives to the cobalt chloride indicator gel were not available to indicate when saturation had occurred in gas/air drying applications, for instance, this could have serious implications on the users' downstream processes, e.g. corrosion through moisture damage.

It has been demonstrated that the vanadium compound VOCl₃, when impregnated into silica gel gives a colour change from colourless to yellow to orange to red to brown as humidity increases according to the following references:

Belotserkovskaya et al., “Indicator properties of vanadium-modified silicas and zeolites” Zh. Prikl. Khim. (Leningrad), 63(8), 1674-9;

Malygin, A. A. “Synthesis and study of physicochemical properties of vanadium-containing silica—a humidity indicator”, Sb. Nauch. Tr. VNII Lyuminoforov I Osobo Chist. Veshchestv, 23, 24-8; and

Malygin, A. A. et al, “Study of properties of vanadium-containing silica gel”, Zh. Prikl. Khim. (Leningrad), 52(9), 2094-6.

However, VOCl₃ is corrosive, toxic and difficult to prepare and handle.

U.S. Pat. No. 2,460,072 and U.S. Pat. No. 2,460,067 also disclose the use of copper(II) chloride and copper(II) bromide, respectively, but the amounts of these used in these patents means that the silica-based products described therein are not considered suitable candidates for a commercial silica-based humidity indicator because of potential toxicity and environmental considerations.

A new system based on copper salts has now been devised, which, surprisingly, provides a very useful indicating desiccant at low copper concentration.

According to the invention, an indicating desiccant comprises a silica-based material having impregnated thereon a source of copper and a source of bromide, the source of copper being present in an amount up to 0.5 per cent by weight, calculated as Cu with respect to weight of the silica-based material, and the source of bromide being present in an amount such that the weight ratio of Br to Cu is at least 5:1.

The silica-based material can be any material capable of acting as a desiccant. Typically, a silica gel is used as the material, but other forms of silica may be used. The silica-based material may have any of the physical forms normally available. In particular, the form can be irregular granules or approximately spherical beads (often called spherical or beaded silica gel).

A particularly useful silica gel has a pore volume as measured by nitrogen porosimetry of between 0.2 and 2.0 cm³g⁻¹ and a BET surface area in the range 200 to 1500 m²g⁻¹. Usually, the average particle size of such a silica gel will be in the range 0.1 to 8 mm.

The source of copper is usually a copper(II) salt. Typical salts include copper(II) sulphate, copper(II) bromide, copper(II) nitrate and copper(II) chloride. The amount of the source of copper, calculated as Cu, is up to 0.5 per cent by weight of the silica-based material, but excellent indicating desiccants can be produced using much lower amounts of Cu. Preferably, the amount of Cu is in the range 0.002 to 0.1 per cent by weight, more preferably in the range 0.01 to 0.07 per cent by weight and even more preferably in the range 0.02 to 0.05 per cent by weight with respect to silica-based material.

The source of bromide can be any material which acts as a source of the bromide ion in the silica-based material. When copper bromide is used as the source of copper, this will provide some of the necessary amount of the source of bromide but an additional source of bromide is necessary. Any water soluble bromide can be used and typical sources of bromide include alkali metal bromides, alkaline earth metal bromides, transition metal bromides and ammonium bromide. Preferred sources of bromide are sodium bromide, potassium bromide, calcium bromide, magnesium bromide, zinc bromide and ammonium bromide.

The amount of the source of bromide present is related to amount of the source of copper present. The ratio of Br to Cu is at least 5:1 by weight and preferably is up to 2000:1 by weight. More preferably, the ratio of Br to Cu is in the range 10:1 to 400:1 by weight and commonly the ratio is in the range 20:1 to 400:1.

Generally, when the amount of Cu present is relatively high, it is possible to produce useful indicating desiccants wherein the ratio of Br to Cu is relatively low. For example, when the amount of source of copper (expressed as Cu) is greater than 0.05 per cent by weight of silica-based material, a suitable Br to Cu ratio is in the range 5:1 to 40:1 by weight. However, when the amount of source of copper (expressed as Cu) is less than about 0.01 per cent by weight of silica-based material, a suitable ratio of Br to Cu is in the range 200:1 to 2000:1 by weight. These ranges for amounts of source of copper and for Br to Cu ratios are often used to produce a general purpose indicating desiccant. Such a desiccant needs to be capable of reducing the relative humidity of a gas to a value below about 30 per cent. Hence, it should show a marked colour change when the amount of water adsorbed is such that the equilibrium relative humidity is in the range 20 to 30 per cent, in order to indicate the need to the user to replenish or reactivate the silica gel. For some desiccant applications a different equilibrium relative humidity may be preferred, in which case other ratios of Br to Cu may be more appropriate if they result in a colour change at a different relative humidity.

The indicating desiccant of the invention generally demonstrates a colour change from dark purple in the absence of moisture to colourless when saturated, or almost saturated, with moisture. The colour of the anhydrous desiccant may be affected by the amount of source of copper present and the ratio of Br to Cu. It is also possible to modify this colour change by also incorporating a dye into the desiccant, particularly one which becomes apparent when the desiccant absorbs water. Therefore, a preferred embodiment of the Invention comprises an indicating desiccant comprising a silica-based material having impregnated thereon a source of copper, a source of bromide and a dye or other coloured material, the source of copper being present in an amount up to 0.5 per cent by weight, calculated as Cu with respect to weight of the silica-based material, and the source of bromide being present in an amount such that the weight ratio of Br to Cu is at least 5:1.

Useful dyes or coloured materials include pink dyes which will impart a pink colour to the humidified silica-based material. These dyes produce a colour change which is similar to the colour change observed with conventional cobalt-containing desiccants. Addition of blue dyes can impart a blue colour to the humidified substrate and addition of iron(III) salts, can impart a yellow colour to the humidified substrate.

In principle, any coloured dye or other coloured material that does not react with the source of bromide or source of copper, either during preparation or use of the desiccant, can be used. Examples of suitable dyes include xanthene-type dyes, such as Rose Bengal (Cl:45440), Phloxine B (Cl:45410), Rhodamine B (Cl:45170) and Erythrosine (Cl:45430); azine-type dyes such as Neutral Red (Cl:50040); thiazine-type dyes such as Methylene Blue (Cl:52015) and triarylmethane dyes such as Naphthazine Blue V (Cl:42045), Patent Blue V (Cl:42045) and Cl Food Blue 2 (Cl:42090). Examples of other coloured materials suitable for this purpose are coloured salts of transition metals, such as salts of vanadium, chromium, manganese, iron, cobalt and nickel. In practice, due to the toxicity of many of these compounds, salts of iron(III) are preferred, especially iron(III) sulphate, ammonium iron(III) sulphate and potassium iron(III) sulphate.

When dyes are used, the amount of dye present is typically from 0.0001 to 0.1 per cent by weight of the silica-based material, preferably 0.001 to 0.01 per cent by weight of the silica-based material. When transition metal salts are used they are preferably present in an amount in the range 0.01 to 2.0 per cent by weight of the silica-based material.

A method of preparing an indicating desiccant according to the invention comprises impregnating a silica-based material with a source of copper and a source of bromide and optionally a dye or other coloured material, thereby introducing into the silica-based material the source of copper in an amount up to 0.5 per cent by weight, calculated as Cu with respect to weight of the silica-based material, and the source of bromide in an amount such that the weight ratio of Br to Cu is at least 5:1.

In a typical process, the indicating desiccant gel is prepared by contacting the silica-based material with a solution of a copper salt containing from 0.05 per cent of the salt by weight up to the saturation concentration of the copper salt, e.g. by soaking a humidified white silica gel in the copper salt solution. Humidified gel (i.e. previously dried silica gel which has been contacted with a source of moisture, such as steam, until the water content is approximately 20 to 30 per cent by weight) is preferred, but the use of dry gel or a hydrogel is acceptable. When dry gel is used, the granules decrepitate, so that the product has a smaller particle size than the original product, but, generally, the particle size is still satisfactory for use as a desiccant agent. For a typical copper salt such as copper(II) sulphate, the solution used may range from 0.1 per cent by weight to approximately 20 per cent by weight (saturation at 25° C.), or higher if higher temperatures are used. Preferably, the solution contains 0.1 to 5 per cent by weight copper(II) sulphate at 25° C. The use of a higher concentration of copper salt helps to reduce the processing time for preparing the indicating silica-based desiccant.

Usually, the solution containing the source of copper used for impregnating the silica-based material also contains the source of bromide. The solubility of suitable sources of bromide, such as sodium bromide, is normally such that there is no problem obtaining a sufficiently concentrated solution and the concentration of the source of bromide in the solution will be determined by the desired ratio of bromide to copper to be achieved.

When a dye or other coloured material is also impregnated onto the silica-based material, this is usually also present in the solution containing the source of copper and the source of bromide. However, very low concentrations, particularly of dyes, may be required and it can, therefore, be difficult to maintain the correct balance of concentrations. Consequently, it is sometimes preferred, especially where the dye has a low water solubility, to impregnate with a dye using an additional impregnation step.

In a typical process, the gel is soaked in the solution for a period of from 10 minutes to 10 days, preferably 1 to 30 hours, more preferably 2 to 24 hours. The excess solution is drained and the gel dried at 80° C. to 230° C. whereupon it develops its dark purple colour. An impregnated product dried in this manner will usually have a weight loss after heating at 145° C. for 16 hours of less than 10 per cent by weight. Preferably, the weight loss at 145° C. is less than 2 per cent by weight.

Alternatively, the silica-based material can be impregnated by mixing with a small amount of a concentrated solution of the impregnants, as described in U.S. Pat. No. 2,460,067. Typically, a silica gel is humidified to about 20 to 30 per cent moisture and then impregnated with a relatively concentrated solution of a copper salt and a source of bromide, the amount of solution used being just sufficient to produce the required loading on the silica. For example, using this method, a loading of about 0.01 per cent Cu by weight and 3 per cent bromide by weight based on silica-based material can be produced by adding about 140 g of a solution containing 0.4 per cent by weight CuSO₄.5H₂O and 30 per cent sodium bromide to 1 kg (dry weight) of humidified silica gel. The silica gel produced contains a ratio of Br to Cu of approximately 240:1. Where a dye is used, this is also added to the silica gel in an appropriate amount by incorporating an appropriate amount of the dye in the solution containing copper and bromide before impregnation of the silica gel. It is sometimes convenient to impregnate the silica gel with separate solutions of the impregnants in sequence. If the dye has a low solubility in water, the gel may be separately impregnated with a dye using an appropriate organic solvent. After the silica gel has been mixed with the solution or solutions it is dried as previously described, typically in the range 80° C. to 230° C.

This technique is preferred to the method wherein the silica gel is soaked in a solution because the additive levels are easier to control. The source of copper and source of bromide are not necessarily absorbed from a common solution in the proportion in which they are present in the solution. Therefore, after a batch of silica gel has been impregnated by soaking, it is usually necessary to adjust the concentrations of the copper source and the bromide source in the soaking solution. This is not a problem with the alternative method using a small amount of relatively concentrated solution. In addition, the amount of dye used is generally very low and it is difficult to control low addition levels using a soaking process. Further, some dyes are more appropriately added using an organic solvent such as alcohol, rather than water.

The silica-based indicating desiccants according to the invention show a strong colour change when they approach the saturation level of water, from dark purple to colourless, or a pale shade when a dye is also present. The colour change is reversible when the desiccant is dried and the desiccant can be used many times. In contrast to the copper bromide desiccants described in U.S. Pat. No. 2,460,067, the colour of the dry material and the relative humidity at which a colour change occurs are hardly affected by the temperature at which the material is dried. Where an alternative colour is preferred, this can readily be produced by adjustment of the amounts of copper and bromide and the ratio of these components. The relative humidity at which a colour change occurs can also be varied by varying the amount and ratios of these components.

The invention is illustrated by the following non-limiting examples.

### EXAMPLES

In the following examples “humidified silica gel” means Sorbsil silica gel, of particle size 2.5 to 6.0 mm, available from INEOS Silicas Limited (formerly Crosfield Limited), which has been exposed to humid air, or steam, until the pore structure contains water to an extent greater than 70% of its capacity to hold water. Typically, such gel contains 22 to 27% water by weight.

The colour changes associated with the indicating gels were determined by placing samples (typically about 9 to 13 grams) into a series of glass tubes and passing air at various relative humidities through the samples for 7 hours at a flow rate of 4 litres/minute. The colours of the products were measured using a Minolta CR200 Chromameter, calibrated to a standard white plate using CIE Illuminate C and an observer angle of 2°. Results were expressed using the L*a*b* system in which L* represents the lightness (the higher the value the lighter the shade), a* the red/green component (positive values are red, negative values are green) and b* the yellow/blue component (positive values yellow, negative values are blue).

### Example 1

Weighed quantities of copper(II) chloride dihydrate and sodium bromide were dissolved in 15 or 10 cm³ water and mixed with humidified gel containing 24.5% water and then dried at 105° C. for 16 hours. The quantities were calculated to give 100 grams of indicating gel after drying.

Compositions (percentages are by weight of the dry product) are given in Table 1.

TABLE 1

| | water used | | | Weight ratio |
|---|---|---|---|---|
| Composition | (cm³) | % Cu | % Br | Br:Cu |
| 1a | 15 | 0.037 | 3.11 | 84:1 |
| 1b | 10 | 0.019 | 3.11 | 164:1 |
| 1c | 10 | 0.0038 | 3.11 | 818:1 |

The indicating gels mentioned in Table 1 were exposed to streams of air at various relative humidities (% R.H.), as described above, and the resulting colours measured and recorded below in Table 2.

TABLE 2

| Composition | % R.H. | L* | a* | b* | Colour |
|---|---|---|---|---|---|
| 1a | 0 | 24.39 | +9.59 | +0.24 | Very dark purple |
| | 20 | 33.79 | +11.81 | +1.72 | Purple |
| | 40 | 58.91 | −0.04 | +3.34 | Almost colourless |
| | 50 | 62.68 | −2.12 | +1.94 | Colourless |
| | 80 | 67.12 | −2.22 | +2.00 | Colourless |
| 1b | 0 | 32.32 | +14.52 | +6.22 | Purplish brown |
| | 20 | 41.27 | +11.17 | +1.40 | Light purple |
| | 40 | 58.53 | −0.40 | +1.93 | Colourless |
| | 50 | 64.19 | −0.70 | +1.97 | Colourless |
| | 80 | 67.44 | −1.54 | +2.04 | Colourless |
| 1c | 0 | 49.31 | +6.82 | +15.59 | Peach/yellow |
| | 20 | 51.97 | +6.35 | −0.14 | Pale purple |
| | 40 | 61.78 | −0.56 | +0.67 | Colourless |
| | 50 | 64.72 | −0.82 | +0.63 | Colourless |
| | 80 | 61.72 | −0.67 | +0.39 | Colourless |

In each case a pronounced colour change was observed, especially for exposure to air between 20 and 40% R.H.

### Example 2

Weighed quantities of copper(II) sulphate pentahydrate and sodium bromide were dissolved in 5 to 10 cm³ water and mixed with humidified gel containing 24.5% water and then dried at 150° C. for 16 hours. The quantities were calculated to give 100 grams of indicating gel after drying. Compositions (percentages are by weight of the dry product) are shown in Table 3 below.

TABLE 3

| | water used | | | Weight ratio |
|---|---|---|---|---|
| Composition | (cm³) | % Cu | % Br | Br:Cu |
| 2a | 10 | 0.026 | 3.11 | 120:1 |
| 2b | 9 | 0.013 | 3.10 | 238:1 |
| 2c | 5 | 0.0025 | 3.10 | 1240:1 |

The indicating gels in Table 3 were exposed to streams of air at various relative humidities (% R.H.), as described above, and the resulting colours measured and recorded below in Table 4.

TABLE 4

| Composition | % R.H. | L* | a* | b* | Colour |
|---|---|---|---|---|---|
| 2a | 0 | 24.15 | +12.04 | +1.70 | Very dark purple |
| | 20 | 35.66 | +12.88 | +0.05 | Purple |
| | 40 | 58.92 | −0.37 | +1.76 | Almost colourless |
| | 50 | 64.56 | −1.38 | +1.15 | Colourless |
| | 80 | 63.97 | −1.76 | +0.99 | Colourless |
| 2b | 0 | 33.95 | +15.04 | +6.21 | Purplish brown |
| | 20 | 46.68 | +10.48 | −0.05 | Light purple |
| | 40 | 58.46 | −0.46 | +1.10 | Colourless |
| | 50 | 61.85 | −0.99 | +0.36 | Colourless |
| | 80 | 61.89 | −1.06 | +0.57 | Colourless |
| 2c | 0 | 48.08 | +3.68 | +13.68 | Light yellow |
| | 20 | 53.07 | +5.18 | −0.68 | Pale pink |
| | 40 | 64.02 | −0.39 | −0.15 | Colourless |
| | 50 | 62.39 | −0.38 | −0.16 | Colourless |
| | 80 | 63.58 | −0.60 | +0.42 | Colourless |

In each case a pronounced colour change was observed, especially when exposed to air with a relative humidity between 20 and 40%.

### Example 3

Weighted quantities of copper(II) chloride dihydrate and magnesium bromide hexahydrate were dissolved in 7 cm³ water and mixed with humidified gel containing 24.5% water and then dried at 105° C. for 16 hours. The quantities were calculated to give 100 grams of indicating gel after drying. Compositions (percentages are by weight of the dry product) are described in Table 5 below.

TABLE 5

| | water used | | | Weight ratio |
|---|---|---|---|---|
| Composition | (cm³) | % Cu | % Br | Br:Cu |
| 3a | 7 | 0.036 | 1.64 | 46:1 |
| 3b | 7 | 0.018 | 3.28 | 182:1 |
| 3c | 7 | 0.0039 | 6.59 | 1690:1 |

The indicating gels mentioned in Table 5 were exposed to streams of air at various relative humidities (% R.H.), as described above, and the resulting colours measured and recorded in Table 6 below.

TABLE 6

| Composition | % R.H. | L* | a* | b* | Colour |
|---|---|---|---|---|---|
| 3a | 0 | 22.54 | +7.80 | −0.20 | Very dark purple |
| | 20 | 41.79 | +6.46 | +6.11 | Light purplish brown |
| | 40 | 59.00 | −2.17 | +1.22 | Almost colourless |
| | 50 | 64.13 | −2.40 | −0.50 | Colourless |
| | 80 | 65.83 | −2.30 | −0.29 | Colourless |
| 3b | 0 | 29.86 | +12.64 | +6.60 | Brown |
| | 20 | 44.43 | +11.58 | −0.10 | Light purple |
| | 40 | 59.54 | +0.35 | +2.08 | Colourless |
| | 50 | 67.90 | −1.56 | +1.47 | Colourless |
| | 80 | 71.77 | −1.61 | +1.56 | Colourless |
| 3c | 0 | 49.37 | +4.99 | +27.68 | Yellow |
| | 20 | 56.75 | +5.94 | −1.43 | Very pale pink |
| | 40 | 65.06 | −0.53 | +0.79 | Colourless |
| | 50 | 65.41 | −0.78 | +1.27 | Colourless |
| | 80 | 67.93 | −0.76 | +1.72 | Colourless |

In each case a pronounced colour change was observed, especially when exposed to air between 20 and 40% R.H.

### Example 4

100 grams of humidified silica gel containing approximately 25% water was soaked in 200 cm³ of a solution containing copper(II) sulphate and sodium bromide in various proportions and stirred every hour. After 4 hours the gel was drained and then dried in an oven at 105° C. for 16 hours.

The percentages of Cu and Br in the dry gel were determined by analysis and are shown in Table 7 below.

TABLE 7

| | | | Composition | | |
|---|---|---|---|---|---|
| | Solution composition | | of dry gels | | |
| | % | % | % | % | Ratio |
| Composition | CuSO₄ · 5H₂O | NaBr | Cu | Br | Br:Cu |
| 4a | 1.56 | 15 | 0.0593 | 2.64 | 45:1 |
| 4b | 0.47 | 20 | 0.0215 | 5.39 | 251:1 |
| 4c | 0.78 | 20 | 0.0257 | 4.30 | 167:1 |
| 4d | 0.78 | 10 | 0.0241 | 2.27 | 94:1 |

The indicating gels in Table 7 were exposed to streams of air at various relative humidities (% R.H.), as described above, and the resulting colours measured and recorded below in Table 8.

TABLE 8

| Composition | % R.H. | L* | a* | b* | Colour |
|---|---|---|---|---|---|
| 4a | 0 | 15.00 | +7.47 | −0.18 | Very dark purple |
| | 20 | 29.79 | +10.50 | +2.38 | Dark brown |
| | 40 | 60.51 | −1.64 | +3.83 | Very pale greenish |
| | 50 | 60.02 | −2.40 | +3.43 | Very pale greenish |
| | 80 | 62.67 | −3.27 | +1.74 | Very pale greenish |
| 4b | 0 | 26.42 | +15.34 | +1.75 | Deep purple |
| | 20 | 35.26 | +12.16 | −1.07 | Purple |
| | 40 | 58.24 | +2.59 | +2.44 | Pale purplish brown |
| | 50 | 60.95 | −0.35 | +1.20 | Colourless |
| | 80 | 64.98 | −0.96 | +1.60 | Colourless |
| 4c | 0 | 24.94 | +20.14 | +2.10 | Deep purple |
| | 20 | 38.13 | +13.50 | +0.54 | Purple |
| | 40 | 61.06 | +0.72 | +2.78 | Colourless |
| | 50 | 68.34 | −0.57 | +3.02 | Colourless |
| | 80 | 69.47 | −1.79 | +1.82 | Colourless |
| 4d | 0 | 23.98 | +14.47 | +0.78 | Deep purple |
| | 20 | 40.57 | +10.26 | +4.10 | Purplish brown |
| | 40 | 66.59 | −1.75 | +1.14 | Very pale greenish |
| | 50 | 63.99 | −2.20 | −0.28 | Very pale greenish |
| | 80 | 68.15 | −2.50 | −0.04 | Very pale greenish |

In each case a pronounced colour change was observed, especially when exposed to air of relative humidity between 20 and 40%.

The water absorption capacities of Sample 4b above were also determined, and compared to a control (a sample of the same humidified gel that had been redried but without having been impregnated with the indicating chemicals). Table 9 below shows the weight % of moisture absorbed by the gel by exposure to air as described above at each of the relative humidities examined.

TABLE 9

| | Wt % Moisture absorbed | |
|---|---|---|
| % R.H. | Control | Example 4b |
| 0 | 0 | 0 |
| 20 | 11.2 | 13.1 |
| 40 | 25.2 | 22.2 |
| 50 | 27.4 | 25.1 |
| 80 | 30.6 | 28.3 |

The absorption capacity of the gel containing indicating chemicals is essentially similar to untreated gel.

### Example 5

15 cm³ of a solution containing 0.1005 g copper(II) sulphate pentahydrate and 7.9993 g sodium bromide was prepared. To this was added 6.0 cm³ of a 0.1% solution of Phloxine B, sodium salt (Cl:45410). This solution was then mixed with 273 grams of humidified silica gel containing 26.7% water and the mixture dried for 16 hours at 145° C. The total weight of solids was 208.2 g.

Composition of the dry product was: Dye 0.003%; Cu 0.012%; Br 2.98%; Ratio Br:Cu, bt weight, 248:1. The indicating gel was exposed to streams of air at various relative humidities (% R.H.), as described above, and the resulting colours measured and recorded below in Table 10.

TABLE 10

| % R.H. | L* | a* | b* | Colour |
|---|---|---|---|---|
| 0 | 42.26 | +14.29 | +15.33 | Purplish brown |
| 20 | 49.08 | +14.38 | +1.57 | Light purple |
| 40 | 64.02 | +8.05 | +4.98 | Pale pink |
| 50 | 68.46 | +9.18 | +3.43 | Pale pink |
| 80 | 70.77 | +6.85 | +2.42 | Pale pink |

The pink colour of the dye becomes apparent after the purple colour of the indicating chemicals has faded.

### Example 6

Weighed quantities of copper(II) sulphate pentahydrate and sodium bromide were dissolved in 5 or 17 cm³ water and 3 or 6 cm³ respectively of 0.1% Phloxine B solution added. The resulting solution was mixed with 136 or 273 g, respectively, of humidified gel containing 26.7% water and then dried at 105° C. for 16 hours. Compositions (percentages are by weight of the dry product) are given in Table 11 below.

TABLE 11

| | water used | % | % | % | Weight ratio |
|---|---|---|---|---|---|
| Composition | (cm³) | dye | Cu | Br | Br:Cu |
| 6a | 5 | 0.003 | 0.020 | 1.15 | 57:1 |
| 6b | 17 | 0.003 | 0.020 | 2.98 | 149:1 |

The indicating gels in the table above were exposed to streams of air at various relative humidities (% R.H.), as described above, and the resulting colours measured and recorded below in Table 12.

TABLE 12

| Composition | % R.H. | L* | a* | b* | Colour |
|---|---|---|---|---|---|
| 6a | 0 | 26.95 | +17.11 | +2.62 | Deep purple |
| | 20 | 59.01 | +5.59 | +3.12 | Pale pink |
| | 40 | 63.64 | +7.63 | +3.12 | Pale pink |
| | 50 | 62.64 | +8.13 | +1.31 | Pale pink |
| | 80 | 67.56 | +5.26 | +0.90 | Pale pink |
| 6b | 0 | 27.38 | +18.18 | +1.60 | Deep purple |
| | 20 | 49.91 | +11.02 | +2.46 | Light purple |
| | 40 | 64.51 | +5.34 | +4.82 | Pale pink |
| | 50 | 71.86 | +5.49 | +2.58 | Pale pink |
| | 80 | 72.95 | +3.76 | +2.95 | Pale pink |

Composition 6b, with the higher Br:Cu ratio, changes colour when exposed to air at a higher humidity than does composition 6a. In both cases the colour of the pink dye becomes visible as the initial purple colour of the copper/bromide system fades.

### Example 7

A sample similar to Sample 3b of Example 3 was prepared except that a beaded silica gel was used and another dye was added to give an alternative colour to the humidified product. The gel used had a particle size of approximately 1 to 3 mm and was manufactured by Engelhard Corp., 600 E. McDowell Road, Jackson, Miss. 39204, USA. A sample weighing 100 grams of this gel was first exposed to a humid atmosphere until it contained 25.8% water. To the humidified gel was added 14 cm³ of a solution containing 0.0505 g copper(II) chloride dihydrate, 6.0249 g magnesium bromide dihydrate and 5 cm³ of a 0.1% solution of Erythrosine B, sodium salt (Cl:45430). The mixture was dried at 105° C. for 16 hours. Assuming no dehydration of the hydrated salts, the total weight of combined solids was 106.3 g. Composition (percentages are by weight of the dry product) of the product was: Dye 0.005%; Cu 0.018%; Br 3.10%; Br: Cu ratio 172:1 by weight. The indicating gel was exposed to streams of air at various relative humidities (% R.H.), as described above, and the resulting colours measured and recorded in Table 13 below.

TABLE 13

| % R.H. | L* | a* | b* | Colour |
|---|---|---|---|---|
| 0 | 26.05 | +16.57 | +19.45 | Dark brown |
| 20 | 25.66 | +11.94 | +4.66 | Brown/purple |
| 40 | 46.75 | +10.34 | +16.98 | Light orange |
| 50 | 47.31 | +12.18 | +17.49 | Light orange |
| 80 | 53.32 | +12.06 | +19.23 | Light orange |

The orange colour of the dye becomes apparent after the darker colour of the indicating chemicals has faded.

### Example 8

Approximately 50 gram portions of the gels of Example 5 and Sample 6b of Example 6 were humidified by exposure to air at nearly 100% R.H. When the colour change was completed their colours were measured and the samples then redried in an oven for 16 hours at 145° C. (Example 5) or 105° C. (Example 6b). Their colours were remeasured and the process repeated. The results are summarised below in Tables 14 and 15.

TABLE 14
Regeneration of Example 5.

| State of gel | % R.H. | L* | a* | b* | Colour |
|---|---|---|---|---|---|
| Fresh | 0 | 42.26 | +14.29 | +15.33 | Purplish brown |
| | 100 | 60.74 | +7.17 | +2.04 | Pale pink |
| Regenerated | 0 | 36.59 | +10.02 | +9.26 | Purplish brown |
| | 100 | 47.08 | +12.50 | +1.85 | Light pink |

TABLE 15
Regeneration of Example 6b

| State of gel | % R.H. | L* | a* | b* | Colour |
|---|---|---|---|---|---|
| Fresh | 0 | 27.38 | +18.18 | +1.60 | Deep purple |
| | 100 | 54.07 | +6.47 | +1.43 | Pale pink |
| Regenerated | 0 | 30.60 | +16.75 | +5.08 | Deep purple |
| | 100 | 60.80 | +10.62 | +0.91 | Light pink |

In both cases regeneration had not significantly affected the dry or humidified colours of the gels.

1. An indicating desiccant comprising a silica-based material having impregnated thereon a source of copper and a source of bromide, the source of copper being present in an amount up to 0.5 per cent by weight, calculated as Cu with respect to weight of the silica-based material, and the source of bromide being present in an amount such that the weight ratio of Br to Cu is at least 5:1.

2. An indicating desiccant according to claim 1 characterised in that the silica-based material is silica gel.

3. An indicating desiccant according to claim 2 characterised in that the silica gel has a pore volume as measured by nitrogen porosimetry in the range 0.2 to 2.0 cm³g⁻¹ and a BET surface area in the range 200 to 1500 m²g⁻¹.

4. An indicating desiccant according to any one of the preceding claims characterised in that the source of copper is a copper salt selected from the group consisting of copper(II) sulphate, copper(II) bromide, copper(II) nitrate and copper(II) chloride.

5. An indicating desiccant according to any one of the preceding claims characterised in that the source of copper is present in an amount in the range 0.02 to 0.05 percent, calculated as Cu, by weight with respect to weight of silica-based material.

6. An indicating desiccant according to any one of the preceding claims characterised in that the source of bromide is a salt selected from the group consisting of sodium bromide, potassium bromide, calcium bromide, magnesium bromide, zinc bromide and ammonium bromide.

7. An indicating desiccant according to any one of the preceding claims characterised in that the ratio of bromide to copper is in the range 20:1 to 400:1 by weight.

8. An indicating desiccant according to any one of claims 1 to 6 characterised in that the amount of source of copper present is in the range 0.05 to 0.5 per cent, calculated as Cu, by weight with respect to weight of silica-based material and the ratio of Br to Cu is in the range 5:1 to 40:1 by weight.

9. An indicating desiccant according to any one of claims 1 to 6 characterised in that the amount of source of copper present is less than 0.01 per cent, calculated as Cu, by weight with respect to weight of silica-based material and the ratio of Br to Cu is in the range 200:1 to 2000:1 by weight.

10. An indicating desiccant according to any one of the preceding claims characterised in that the desiccant further comprises a dye or other coloured material.

11. An indicating desiccant according to claim 10 characterised in that the dye is a xanthene-type dye, an azine-type dye, a thiazine-type dye or a triarylmethane dye.

12. An indicating desiccant according to claim 10 or 11 characterised in that the dye is present in an amount in the range 0.0001 to 0.1 per cent by weight of the silica-based material.

13. A method of preparing an indicating desiccant comprising impregnating a silica-based material with a source of copper and a source of bromide and optionally a dye or other coloured material, thereby introducing into the silica-based material the source of copper in an amount up to 0.5 per cent by weight, calculated as Cu with respect to weight of the silica-based material, and the source of bromide in an amount such that the weight ratio of Br to Cu is at least 5:1.

14. A method according to claim 13 characterised in that a humidified silica gel containing from 20 to 30% by weight water is soaked in a solution containing from 0.1 to 20 percent by weight of a copper salt and a source of bromide for a period in the range 2 to 24 hours, excess solution is drained from the treated silica gel and the silica gel is dried at a temperature in the range 80° C. to 230° C.

15. A method according to claim 13 characterised in that the silica gel is impregnated by mixing a humidified silica gel containing from 20 to 30 per cent moisture by weight with a solution containing a source of copper and a source of bromide, and optionally a dye or other coloured material, the amount of solution used being just sufficient to produce the required loading of copper and bromide on the silica gel, and subsequently drying the treated silica gel at a temperature in the range 80° C. to 230° C.
